(19) United States
(12) Patent Application Publication
(10) Pub. No.: US 2008/0027794 A1
(43) Pub. Date: Jan. 31, 2008

(54) Bicycle, A Method of Managing a Fleet of Bicycles, and A System of Managing Such a Fleet

(75) Inventors: Jacques Le Gars, Gambais (FR); Jacques Paris, Plaisir (FR); Patrick Tavernier, Bouafle (FR)

Correspondence Address: MILLER, MATTHIAS & HULL, ONE NORTH FRANKLIN STREET, SUITE 2350, CHICAGO, IL, 60606, US

(73) Assignee: JCDecaux SA, Neuilly Sur Seine (FR)

(21) Appl. No.: 11/781,709

(22) Filed: Jul. 23, 2007

(30) Foreign Application Priority Data
Jul. 25, 2006 (FR) FR06 06814

(51) Int. Cl. G06Q 20/00; B62K 3/00

(52) U.S. Cl. 705/13; 280/261

(57) ABSTRACT

A bicycle including an impact detection device and a monitoring central processing unit connected to said impact detection device.

The invention relates to a bicycle, a method of managing a fleet of bicycles, and a system of managing such a fleet.

### BACKGROUND OF THE DISCLOSURE

Today, certain cities are equipped with automatic bicycle hire systems enabling any user to hire a bicycle for a journey.

Such systems comprise a plurality of fixed terminal posts, it being possible to fasten at least one bicycle to each of them, said terminal posts being connected to an automatic logic controller provided with a user interface enabling a user to cause a bicycle to be unlocked in exchange for giving specific information, such as the user's bank details or a predetermined user code.

A bicycle for such a system, which bicycle includes a monitoring central processing unit (CPU), is described in particular in Documents WO-A-02/09 5698 and WO-A-01/54080.

When the user looks after it, the hired bicycle requires little maintenance. Otherwise, and, in particular, when the user rides up curbs without taking care not to cause the wheels, and in particular the back wheel, to be subjected to any impact, maintenance on the bicycle can be considerable.

Such improper use of the bicycle gives rise to a considerable increase in the number of punctures, and of buckled wheels. In practice, two-thirds of punctures and most buckled wheels affect the back wheels which are subjected to greater impacts when riding suddenly up an obstacle, such as a curb, for example.

It would therefore be very useful to detect improper use of the bicycles, e.g. so as to inform the user or so as to inform the manager of the fleet of bicycles (who can then, for example, trigger a preventive maintenance operation or indeed impose a penalty on the user who is responsible for the improper use).

### SUMMARY OF THE DISCLOSURE

To this end, the bicycle of the disclosure includes an impact detection device connected to the monitoring central processing unit.

It is thus possible to detect the impacts suffered by the bicycle, such impacts being symptomatic of improper use that might damage the bicycle.

In various embodiments of the bicycle of the invention, it is optionally possible to use one or more of the following provisions:
the bicycle is adapted to be locked to a fixed locking station which communicates with at least one bicycle management device, said monitoring central processing unit being adapted to communicate with said locking station;
the monitoring central processing unit is adapted to communicate with a bicycle management device;
the monitoring central processing unit is adapted to indicate to the bicycle management device that an impact has been detected;
the monitoring central processing unit is adapted to store a parameter as a function of the number of impacts detected by the impact detection device and/or of the magnitudes of said impacts;
the monitoring central processing unit is adapted to transmit said parameter to a bicycle management device;
an interface adapted to deliver information to a user may be provided, and the monitoring central processing unit is adapted to deliver information relating to the past impact detections to the user, via said interface;
the bicycle includes a frame, a front wheel and a back wheel, and the impact detection device is fixed to the frame in the vicinity of the back wheel;
the impact detection device comprises an accelerometer;
the impact detection device is adapted to detect an impact when it measures an acceleration greater than a predetermined value; and
the monitoring central processing unit is adapted to determine that an impact has taken place when the impact detection device measures an acceleration that is greater than a predetermined value.

The invention also provides a management method for managing a fleet of bicycles including at least one bicycle as mentioned above, said method comprising the following steps:
hiring a bicycle; and
detecting an impact on the hired bicycle.

The method of the invention may further comprise one or more of the following steps:
transmitting a parameter indicative of an impact to a system for managing a fleet of bicycles;
determining a transaction amount as a function of at least one parameter indicative of the impact detections during hire use;
determining pricing to be applied to the user as a function of the past impact detections; and
selectively triggering a maintenance operation as a function of the past impact detections.

The invention also provides a management system for managing a fleet of bicycles including at least one bicycle as mentioned above, said system comprising at least one management device suitable for implementing the above-mentioned management method.

This system may further comprise at least one fixed locking station which communicates with at least one bicycle management device and which is adapted to communicate with a bicycle of the fleet when said bicycle is locked to said locking station.

The invention can be well understood and its advantages appear more clearly on reading the following detailed description of embodiments given by way of non-limiting example.

### BRIEF DESCRIPTION OF THE DRAWINGS

The description refers to the accompanying drawings, in which:

FIG. 1 is a perspective view diagrammatically showing a system for managing a fleet of bicycles;

FIG. 2 is a block diagram diagrammatically showing the internal organization of the system of FIG. 1; and

FIG. 3 is a flow chart showing a method of the invention for managing a fleet of bicycles.

### MORE DETAILED DESCRIPTION

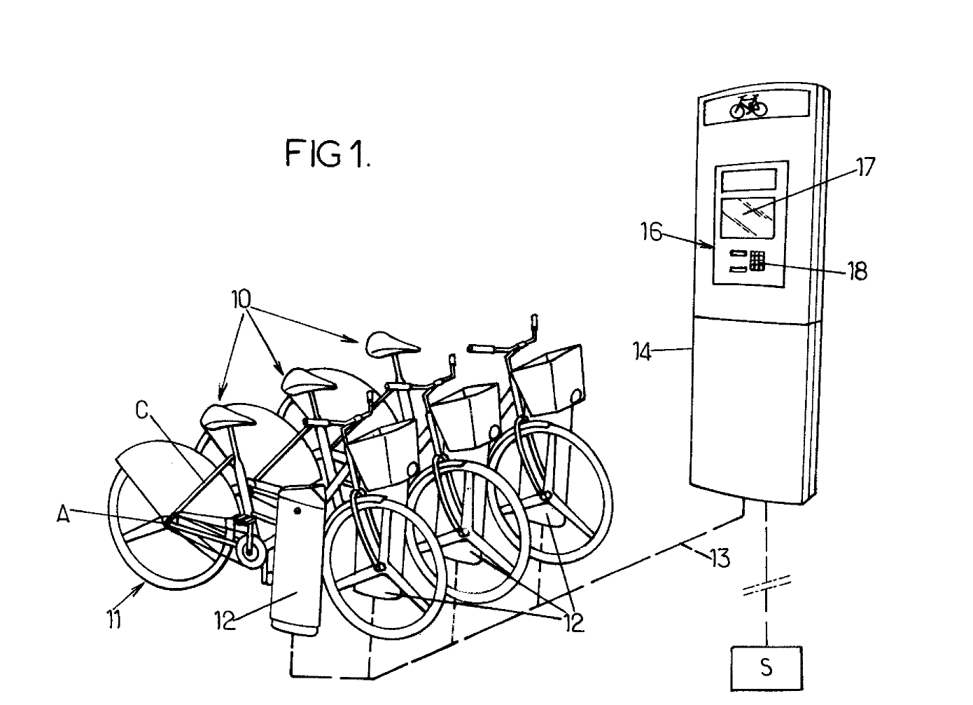

FIG. 1 shows a system for managing a fleet of bicycles 10 that are for hire, in particular in an urban environment.

In FIG. 1, the bicycles 10 are shown in the returned position in which each of them is fixed temporarily to a locking station such as a storage terminal post 12 that is provided with a locking system (not shown) which co-operates with fastener means (not shown) provided on the bicycle 10 for preventing it from being used by any unauthorized person.

The storage terminal posts 12 can be grouped together into one or more bicycle storage zones, only one zone being shown in FIG. 1.

The storage terminal posts 12 in the same zone are connected, e.g. via an underground cable 13 (shown in dashed lines), to an interactive terminal post 14 that is accessible to users.

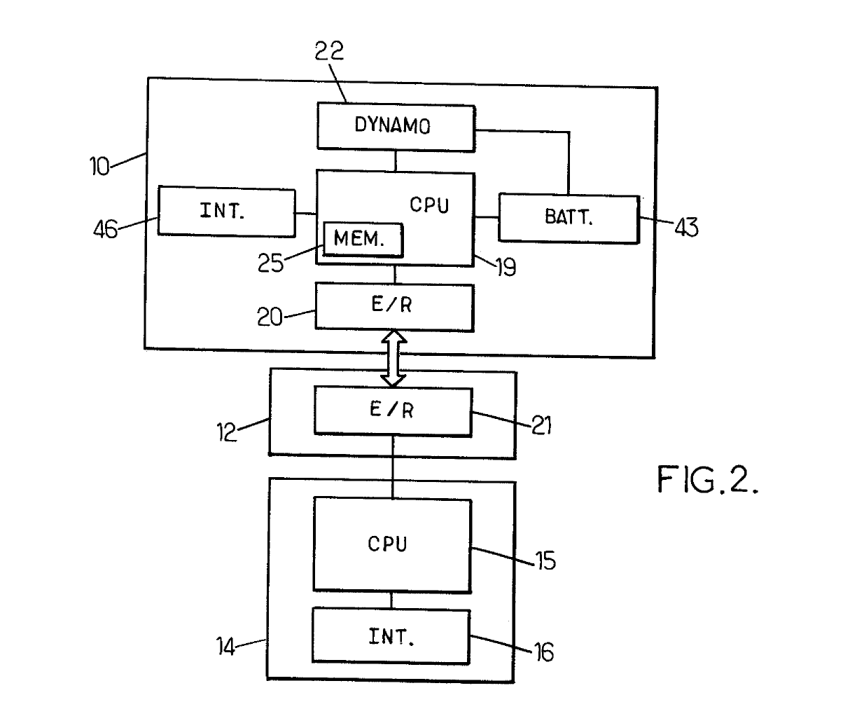

With reference to FIG. 2, said interactive terminal post 14 includes a monitoring central processing unit (CPU) 15, and a user interface 16 connected to the CPU 15. The interactive terminal post 14 is preferably provided with a screen 17 and with a keypad 18. As shown in FIG. 1, the interactive terminal post 14 of each station can communicate remotely with a device (or a server) S for managing the fleet of bicycles.

Each bicycle is also equipped with a monitoring central processing (CPU) 19 and with a transceiver 20 connected to the CPU 19.

Each storage terminal post 12 is equipped with a transceiver 21, the transceivers 20, 21 jointly forming a communications interface between the CPU 15 of the interactive terminal post 14 and the CPU 19 of the bicycle 10.

At the request of a user, the locking system of a given storage terminal post 12 can be deactivated under the control of the interactive terminal 14 so as to enable the user to make use of the corresponding cycle 10. Such unlocking can, for example, be performed on authorization from the management server S (shown diagrammatically in FIG. 1), after the user has identified himself/herself on the interactive terminal post 14. Such identification is, for example, performed by means of an electronic card, of a code, or by any other equivalent means.

The CPU 19 of the bicycle 10 can, for example, receive a specific identifier associated with the user from the interactive terminal post 14 during authorization of the hire.

With reference to FIG. 2, in order to supply electrical power to the bicycle 10, said bicycle is further provided with a dynamo 22 mounted on one of the wheels of the bicycle 10 and electrically connected to the CPU 19, and with a battery of storage cells 23 electrically connected both to the dynamo 22 and to the CPU 19.

The CPU 19 of the bicycle 10 further includes an internal memory 25 of the Flash type in which, as explained below, one or more values can be stored.

The CPU 19 is programmed to detect an impact on the back wheel 11 of the hired bicycle 10. Such detection can be made by means of an impact detection device, which device is constituted by an accelerometer A in this example, with which the frame C of the bicycle 10 is equipped in the vicinity of the back wheel 11. The accelerometer is connected electrically to the CPU 19.

This impact detection device A can be adapted to detect an impact when it measures an acceleration that is greater than a predetermined value. In a variant, it can be the CPU 19 that is adapted to determine that an impact has taken place when the impact detection device A measures an acceleration that is greater than a predetermined value.

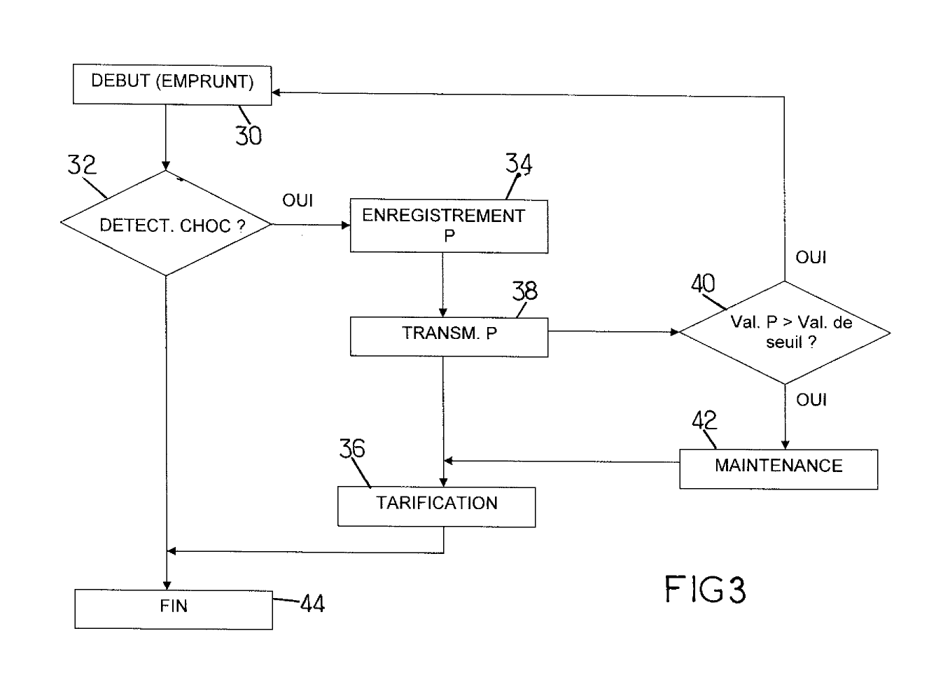

A method of managing the fleet is described below with reference to FIG. 3.

The method of the invention for managing the fleet includes a first step 30 for hiring the bicycle 10. This step 30 consists practically in unlocking the corresponding storage terminal post 12 under the control of the CPU 15 of the interactive terminal post 14.

If the bicycle is then subjected to a relatively violent impact while it is being used, that impact is then detected by the impact detection device A during the impact detection step 32.

Whenever an impact is detected on the hired bicycle 10, the user of the bicycle can be warned (e.g. for dissuasive purposes) by information being delivered via an interface 46 provided for this purpose on the bicycle 10 and enabling, for example, sound activation to take place or display to take place, in particular on a screen.

The CPU 19 of the bicycle can be adapted to store, by means of the memory 25, during a recording step 34, a parameter P representing the number of impacts detected by the impact detection device A and/or the magnitude of each of said impacts.

Impact detection can also trigger a transmission step 38 during which the CPU 19 of the bicycle transmits the parameters P representative of the past impacts (or any other parameter depending on said parameters P) directly to the management server S and/or via a locking station.

When the transmission of a parameter P takes place via a locking station, it preferably takes place via the storage terminal post 12 and via the interactive terminal post 14, just before the end of the transaction, when the user returns the bicycle to a storage terminal post 12 (return step).

When the transmission takes place direct to the management server S, the step 38 can optionally take place throughout the hire, if the bicycle is continuously in communication with said server, by means of a relatively long-range radio-communications interface (not shown).

As a function of the parameters P corresponding to the past impacts, it is also possible, during a step 36, to determine a transaction amount that depends on the number and/or on the magnitude of the impacts received during the hire of the bicycle 10.

This pricing step 36 is preferably performed at the end of the hire as soon as the parameters P have been transmitted to the management server S (step 38) after the bicycle has been returned.

At the end of the transaction (step 44), the user can be informed of the amount of the transaction, e.g. via the user interface 16 of the interactive terminal post 14. It can be understood that the user can be informed directly on the hired bicycle 10 via the user interface 46 provided on the bicycle 10, e.g. as a function of information received from the management server S.

The user interface 46 can also, at the end of the transaction, deliver information to the user, e.g. the number of impacts recorded during the hire and/or their magnitudes.

In addition, as soon as the parameters P are transmitted to the management server S, they are compared with a threshold value beyond which a maintenance step 42 is activated. The maintenance step 42 can, for example, include a wheel change when a wheel is buckled and/or a tire change when a tire is punctured.

The step 40 for comparing the indicative parameter P with the threshold value can also make it possible to change the customer to a different category, by putting the customer in a “bad user” category, and thus to apply higher prices. The customer can then be informed of the change of category and of the change of price.

Optionally, the user can also be warned that, if the user's bad behavior continues, the user's subscription may be suspended for a given time, etc. That information is also preferably delivered to the user the next time said user hires a bicycle.

What is claimed is:

1. A bicycle including a monitoring central processing unit and an impact detection device connected to said monitoring central processing unit, said monitoring central processing unit being adapted to communicate with a bicycle management device.

2. A bicycle according to claim 1, adapted to be locked to a fixed locking station which communicates with at least one bicycle management device, said monitoring central processing unit being adapted to communicate with said locking station.

3. A bicycle according to claim 2, in which the monitoring central processing unit is adapted to indicate to the bicycle management device that an impact has been detected.

4. A bicycle according to claim 1, in which the monitoring central processing unit is adapted to store a parameter as a function of the number of impacts detected by the impact detection device and/or of the magnitude of said impacts.

5. A bicycle according to claim 4, in which the monitoring central processing unit is adapted to transmit said parameter to a bicycle management device.

6. A bicycle according to claim 1, further including an interface adapted to deliver information to a user, and in which the monitoring central processing unit is adapted to deliver information relating to the past impact detections to the user, via said interface.

7. A bicycle according to claim 1, including a frame, a front wheel and a back wheel, and in which the impact detection device is fixed to the frame in the vicinity of the back wheel.

8. A bicycle according to claim 7, in which the impact detection device comprises an accelerometer.

9. A bicycle according to claim 1, in which the impact detection device is adapted to detect an impact when it measures an acceleration greater than a predetermined value.

10. A bicycle according to claim 8, in which the monitoring central processing unit is adapted to determine that an impact has taken place when the impact detection device measures an acceleration that is greater than a predetermined value.

11. A management method for managing a fleet of bicycles including at least one bicycle according to claim 1, said method comprising the following steps:
hiring a bicycle; and
detecting an impact on the hired bicycle.

12. A management method according to claim 11, further comprising a transmission step for transmitting a parameter indicative of an impact to a system for managing a fleet of bicycles.

13. A management method according to claim 11, further comprising a step for determining a transaction amount as a function of at least one parameter indicative of the impact detections during use.

14. A management method according to claim 11, further comprising a step for determining pricing to be applied to the user as a function of the past impact detections.

15. A management method according to claim 11, further comprising a step for selectively triggering a maintenance operation as a function of the past impact detections.

16. A management system for managing a fleet of bicycles including at least one bicycle according to claim 1, said system comprising at least one management device suitable for implementing the management method comprising the following steps:
hiring a bicycle; and
detecting an impact on the hired bicycle.

17. A management system according to claim 16, said management system further comprising at least one fixed locking station which communicates with at least one bicycle management device and which is adapted to communicate with a bicycle of the fleet when said bicycle is locked to said locking station.

18. A management method for managing a fleet of bicycles including at least one bicycle according to claim 5, said method comprising the following steps:
hiring a bicycle; and
detecting an impact on the hired bicycle.

19. A management method for managing a fleet of bicycles including at least one bicycle according to claim 9, said method comprising the following steps:
hiring a bicycle; and
detecting an impact on the hired bicycle.

20. A management system for managing a fleet of bicycles including at least one bicycle according to claim 5, said system comprising at least one management device suitable for implementing the management method comprising the following steps:
hiring a bicycle; and
detecting an impact on the hired bicycle.
